(19) United States
(12) Patent Application Publication
(10) Pub. No.: US 2023/0348148 A1
(43) Pub. Date: Nov. 2, 2023

(54) CLOSING CAP ASSEMBLY

(71) Applicant: Seidel GmbH & Co. KG, Marburg (DE)

(72) Inventors: Andreas Franz Christian Ritzenhoff, Marburg (DE); Tobias Huehn, Marburg (DE)

(21) Appl. No.: 18/142,155

(22) Filed: May 2, 2023

(30) Foreign Application Priority Data
May 2, 2022 (EP) 22171132.8

(51) Int. Cl. B65D 41/18

(52) U.S. Cl. CPC B65D 41/18; B65D 2251/0015

(57) ABSTRACT

A closing cap assembly (12) for being disposed on a discharge opening (11) of a container (10 includes a multi-piece design, having a protective cap (13) and a collar (14) which is designed as a sleeve, the protective cap (13) and the collar (14) being intended to be disposed on the discharge opening (11), the protective cap (13) having an inner cap (19) which is housed in an enveloping cap (18) and is connected to the enveloping cap (18) via a connective element (28). The connective element serves for establishing a detachable connection to the collar (14) independently of the inner cap (19).

This application claims priority to European Patent Application No. 221711323.8 filed on May 2, 2022, the disclosure of which is incorporated herein by reference.

### TECHNICAL FIELD

The invention relates to a closing cap assembly for being disposed on a discharge opening of a container, the closing cap assembly having a multi-piece design, the closing cap assembly comprising a protective cap and a collar which is designed as a sleeve, the protective cap and the collar being intended to be disposed on the discharge opening, the protective cap having an inner cap which is housed in an enveloping cap and is connected to the enveloping cap via a connective element.

### BACKGROUND

A closing cap assembly of the type mentioned above is known from EP 3 928 657 A2, the closing cap assembly having an inner cap for establishing a connection between the protective cap and the collar disposed on the container opening, the inner cap having a spring cam for forming a connective element, the spring cam being formed in the sleeve part of the inner cap and requiring a specific design of the sleeve part with slits for achieving a desired spring effect of the spring cam such that the spring cam locks with an interlocking member formed as a circumferential bead on the collar.

Although this known solution has proven very successful in the practical use of the protective cap, with regard to the most universal possible use of such a protective cap, i.e. in particular, for example, independently of the dimensions of any dosing pump device to be covered by the protective cap and inserted into the container opening, it has been found that, due to the functionally necessary merely slight oversize of the inner diameter of the inner cap compared to the outer diameter of the collar as a prerequisite for an interlocking effect of the spring cam, there may be limitations with regard to the dosing pump devices which can be inserted into the dispensing opening.

### SUMMARY

The object of the invention at hand is therefore to propose a closing cap assembly having a protective cap with which these limitations regarding the use of the dosing pump devices in combination with the protective cap can be reduced.

According to the invention, the connective element serves to establish a detachable connection to the collar independently of the inner cap.

Owing to the independence of the connective element from the inner cap, it is no longer necessary with the closing cap assembly according to the invention to adapt the inner diameter of the inner cap in a special manner to the outer diameter of the collar in order to ensure the connection between the protective cap and the collar. Furthermore, the exact same connective element serves for connecting the enveloping cap and the inner cap of the protective cap and for establishing the connection between the protective cap and the collar for the closing cap assembly according to the invention. At length, the design of making the connective element independent of the inner cap also enables choosing material for the connective element independently of the material of the inner cap, meaning that choosing a material particularly advantageous for the function of the connective element is possible without impeding the chosen material deemed the most suitable for forming the inner cap. Thus, it is also possible to choose a material for the inner cap with regard to an as effective recycling of the protective cap as possible which coincides with the material of the enveloping cap in order to choose as high a content of material destined for recycling as possible for the protective cap or even the closing cap assembly. Consequently, it is conceivable to choose a material such that the material for the connective element is a plastic material and aluminum for the enveloping cap, the inner cap and the collar.

With regard to separating the material chosen for the closing cap assembly or protective cap preceding the recycling, it is particularly preferable if the connection between the connective element and the collar is a mechanical connection.

The material used is separated particularly easily if the connection is a force-fitting and/or form-fitted connection.

If the connective element is made of a material deviating from the material of the enveloping cap and/or the material of the inner cap, a material combination is possible during the production of the closing cap assembly for which an optimization regarding the corresponding use of the material for forming the connective element, the inner cap, the enveloping cap and/or the collar can take place in the choice of materials.

It is particularly advantageous if the connective element is made of a plastic material and at least the enveloping cap and the cap inner part are made of metal, preferably aluminum, the metal content or rather aluminum content being at least 90%, preferably 92%, particularly preferably 95%, to even allow recycling the closing cap assembly or protective cap if required without having to mechanically separate the connective element beforehand from the combination of the enveloping cap and the protective cap, i.e., the recycling takes place by melting the protective cap from which the particularly low content of a plastic material is thermally eliminated.

In particular when the connective element is made of a shape-elastic plastic material, it is advantageous for using the shape-elastic properties if the connection allowed via the connective element is an interlocking connection.

If the connective element is annular having a radially inward interlocking member, which interacts with a radially outward interlocking member of the collar, for establishing the interlocking connection, a particularly advantageous embodiment of the closing cap assembly is given not only with regard to recycling but also in particular with regard to the use of the closing cap assembly by the consumer who is occupied with the handling of a container, such as a perfume bottle, having a closing cap assembly of this kind.

It is particularly preferred if the connective element connects a lower circumferential edge of the enveloping cap to a lower circumferential edge of the inner cap, meaning the weight content of the connective element can remain comparatively low.

If the connection between the connective element and a lower edge of the collar takes place in such a manner that the connective element rests on a container edge in a connection configuration with the collar, the connective element resting on the collar ensures that a feel of the closing cap assembly is given which has no play in the interlocking configuration and thus appears of high quality to the consumer.

Preferably, the connective element has an annular body having a support edge which is oriented radially outward and rests on a support collar of the enveloping cap oriented radially inward and having an axial support web on which a support edge of the inner cap rests in such a manner that the connective element is subjected only to pressure when releasing the connection between the protective cap and the collar.

Owing to the exclusive subjection of the connection element to pressure when released, the connections persistent between the connective element and both the enveloping cap and the inner cap are correspondingly subjected to pressure and thus not separation of these connections, meaning these connections can be established as pure, frictionally engaged to connections when mounting the protective cap.

If the enveloping body is made of multiple pieces in such a manner that the support collar oriented radially inward is formed on an inner sleeve of the enveloping cap connected to the outer cap of the enveloping cap, the outer sleeve can be provided with a cap bottom forming the upper side of the protective cap, without the mounting mentioned above for combining the enveloping cap with the inner cap by means of the connective element being impeded.

### BRIEF DESCRIPTION OF DRAWINGS

In the following, a preferred embodiment of the closing cap assembly is described in further detail by means of the drawings.

FIG. 1 shows a longitudinal cut of a closing cap assembly disposed on a discharge opening of a container;

FIG. 2 shows an individual illustration and longitudinal cut of the closing cap assembly shown in FIG. 1;

FIG. 3 shows an exploded view of the closing cap assembly shown in FIG. 2.

### DETAILED DESCRIPTION

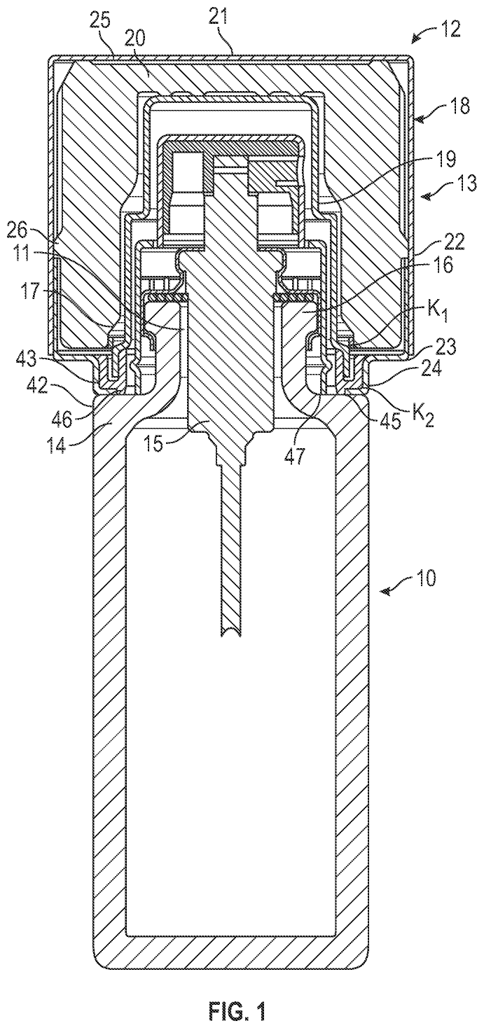

FIG. 1 shows a longitudinal cut through a container 10 which is formed as a flacon in this instance and has a discharge opening 11 formed as a container neck, a closing cap assembly 12 being disposed on discharge opening 11. Closing cap assembly 12 has a multi-piece design having a protective cap 13 and a collar 14 which is formed as a sleeve, is disposed on discharge opening 11 and surrounds a dosing pump device 15 disposed in discharge opening 11. Dosing pump device 15 is crimped to an opening edge 16 of discharge opening 11 by means of a fastening sleeve 16 which is housed between discharge opening 11 and collar 14.

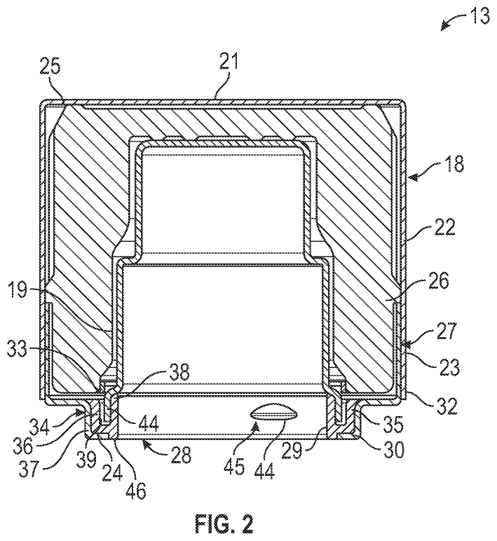

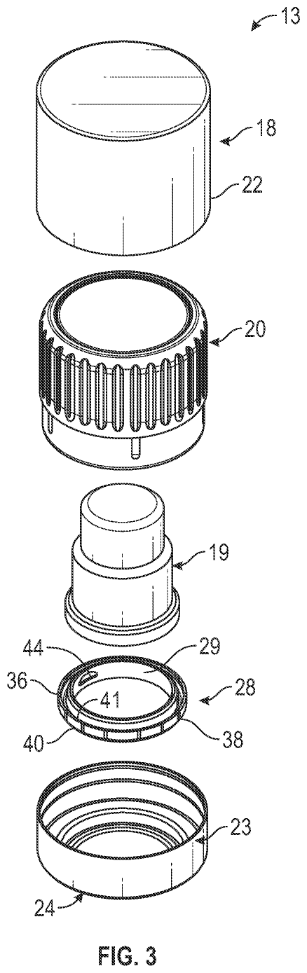

As in particular a combined view of FIGS. 2 and 3 shows, protective cap 13 has an inner cap 19 disposed in an outer enveloping cap 18, a gap formed between enveloping cap 18 and inner cap 19 housing a cap insert 20 in the present instance. Enveloping cap 18 is made in two pieces in the present instance and has an outer sleeve 22 provided with a cap bottom 21 and an inner sleeve 23 which engages in outer sleeve 22 and has a support collar 24.

In the present instance, cap insert 20, which preferably simultaneously forms a cap weight and is made of an aluminum cast, forms a spacer which defines the axial relative position of enveloping cap 18 and inner cap 19. For this purpose, an, in this case, annular cap abutment 25 is formed at the upper end of cap insert 20, against which cap bottom 21 of outer sleeve 22 abuts, and an abutment collar 26 at the circumference of cap insert 20, against which inner sleeve 23 abuts with a sleeve edge 31. The connection between outer sleeve 22 and inner sleeve 23 takes place as a frictionally engaged connection in an engagement area 27 formed between outer sleeve 22 and inner sleeve 23.

To connect enveloping cap 18 to inner cap 19, a connective element 28 is provided which is made of a plastic material in deviation to enveloping cap 18 which is made of aluminum in compliance with inner cap 19 in the present instance. Connective element 28 has an annular body 29 having a support edge 30 which is oriented radially outward and rests on support collar 24 of inner cap 23 oriented radially inward. Furthermore, body 29 has an axial support web 32 which is at a radially inward offset and on which a lower support edge 33 of inner cap 19, which is oriented radially inward, rests.

As clearly shown by the marking of force transmission areas K1 and K2 in FIG. 1, which are formed between enveloping cap 18, connective element 28 and inner cap 19 when protective cap 13 is pulled from discharge opening 11 of container 10, connective element 28 is subjected only to pressure, meaning no separation forces become effective between support collar 24 of enveloping cap 18 and support edge 30 of connective element 28 as well as between support web 32 of connective element 28 and support edge 33 of inner cap 19, and connective element 28 is secured in its relative position between enveloping cap 18 and inner cap 19 via merely frictionally engaged connections 34 and 35.

To establish frictionally engaged connection 34, connective element 28 has an edge web 36 which extends axially from support edge 30 and is disposed concentrically to a clamping edge 37 of enveloping cap 18 also extending axially, ribs 40 extending axially on edge web 36 ensuring an increased clamping effect. To establish a clamping effect of connection 35 between a clamping web 38 disposed radially inward to edge web 36 and a clamping edge 39 of inner cap 19 extending in a gap formed between edge web 36 and clamping web 38, clamping web 38 is equipped with ribs 41.

As FIG. 1 shows, connective element 28 not only serves to connect enveloping cap 18 to inner cap 19 but also to connect protective cap 13 to collar 14 disposed on discharge opening 11. To establish the connection as interlocking connection 42, connective element 28 has a radially inner interlocking connection 43 on annular body 29, interlocking connection 43 being made of three interlocking protrusions 44 distributed equidistantly on the inner circumference of body 29 in the present instance, interlocking protrusions 44 being formed on clamping web 38 of connective element 28 in the present instance. In the locked position of FIG. 1, in which position protective cap 13 is fastened on discharge opening 11 or collar 14, interlocking protrusions 44 of interlocking member 43 engage behind an interlocking device 45 formed as a circumferential groove on collar 14, a lower support edge 46 of connective element 28 simultaneously resting on a container edge 47 formed as a container shoulder below discharge opening 11.

As FIG. 1 shows, connective element 28 connects a lower circumferential edge of enveloping cap 18 formed by support collar 24 in this instance to a lower circumferential edge of inner cap 19 formed in particular by support edge 33 in this instance, the connection being established in such a manner between connective element 28 and a lower portion of collar 14 that collar 14 of connective element 28 rests on container edge 37 in the connection configuration.

As FIG. 1 shows, connective element 28, which is formed independently of inner cap 19 of protective cap 13 and allows a detachable connection between protective cap 13 and collar 14 independently of the design or measurements of inner cap 19, allows inner diameter D of inner cap 19 to be chosen to be significantly larger than outer diameter d of collar 14—for example for housing larger dosing pump devices—without the connection between protective cap 13 and collar 14 being hindered by this.

1. A closing cap assembly (12) for being disposed on a discharge opening (11) of a container (10), the closing cap assembly (12) having a multi-piece design, the closing cap assembly (12) comprising a protective cap (13) and a collar (14) which is formed as a sleeve, the protective cap (13) and the collar (14) being intended to be disposed on the discharge opening (11), the protective cap (13) having an inner cap (19) which is housed in a covering cap (18) and is connected to the enveloping cap (18) via a connective element (28),
characterized in that
the connective element (28) serves for establishing a detachable connection to the collar (14) independently of the inner cap (19).

2. The closing cap assembly according to claim 1,
wherein
the connection between the connective element (28) and the collar (14) is designed as a mechanical connection.

3. The closing cap assembly according to claim 2,
wherein
the connection is designed as a force-fitting and/or form-fitted connection.

4. The closing cap assembly according to claim 1,
wherein
the connective element (28) is made of a material different to the material of the enveloping cap (18) and/or to the material of the inner cap (19).

5. The closing cap assembly according to claim 4,
wherein
the connective element (28) is made of a plastic material and at least the enveloping cap (18) and the inner cap (19) are made of metal, preferably aluminum.

6. The closing cap assembly according to claim 4,
wherein
the connection is designed as an interlocking connection (42).

7. The closing cap assembly according to claim 6,
wherein
the connective element (28) is annular having a radially inner interlocking member (43) for establishing the interlocking connection (42), the interlocking member (43) interacting with a radially outer interlocking member (45) of the collar (14).

8. The closing cap assembly according to claim 1,
wherein
the connective element (28) connects a lower circumferential edge of the enveloping cap to a lower circumferential edge of the inner cap.

9. The closing cap assembly according to claim 8,
wherein
the connection occurs in such a manner between the connective element (28) and a lower part of the collar that the connective element (28) rests on a container edge (47) in a connective configuration with the collar (14).

10. The closing cap assembly according to claim 8,
wherein
the connective element (28) has an annular body (29) having a support edge (30) which is oriented radially outward and rests on a support collar (24) of the enveloping cap (18) oriented radially inward and having an axial support web (32) on which a support edge (33) of the inner cap (19) is supported in such a manner that the connective element (28) is subjected only to pressure when releasing the connection between the protective cap (13) and the collar (14).

11. The closing cap assembly according to claim 10,
wherein
the enveloping cap (18) is made in several pieces, such that the support collar (24) directed radially inward is formed on an inner sleeve (23) of the enveloping cap (18) connected to an outer sleeve (22) of the enveloping cap (18).
